(19) United States
(12) Patent Application Publication
(10) Pub. No.: US 2015/0193563 A1
(43) Pub. Date: Jul. 9, 2015

(54) METHOD FOR CREATING TEMPLATE OF BUILDING COMPONENT, METHOD FOR CREATING PRIMITIVE, AND APPARATUS FOR MODELING BUILDING COMPONENT

(71) Applicant: ELECTRONICS AND TELECOMMUNICATIONS RESEARCH INSTITUTE, Daejeon (KR)

(72) Inventors: Jae Woo KIM, Daejeon (KR); Jin Seo KIM, Daejeon (KR); Ji Hyung LEE, Daejeon (KR); Soon Young KWON, Daejeon (KR); Song Woo LEE, Daejeon (KR); Juyeon YOU, Daejeon (KR); In-Su JANG, Daejeon (KR); Kyung Kyu KANG, Seoul (KR)

(21) Appl. No.: 14/587,264

(22) Filed: Dec. 31, 2014

(30) Foreign Application Priority Data
Jan. 7, 2014 (KR) 10-2014-0002054

(51) Int. Cl. G06F 17/50

(52) U.S. Cl. CPC G06F 17/5004

(57) ABSTRACT

A building component modeling apparatus records a process of creating the first component through at least one first primitive among a plurality of building primitives. The building component modeling apparatus analyzes the process of creating the first component to extract at least one first parameter defining the first component. The building component modeling apparatus creates a template of the first component by using the at least one first parameter.

### CROSS-REFERENCE TO RELATED APPLICATION

This application claims priority to and the benefit of Korean Patent Application No. 10-2014-0002054 filed in the Korean Intellectual Property Office on Jan. 7, 2014, the entire contents of which are incorporated herein by reference.

### BACKGROUND OF THE INVENTION

(a) Field of the Invention

The present invention relates to a method for creating a template of a building component, a method for creating a primitive, and an apparatus for modeling a building component.

(b) Description of the Related Art

Restoration (or recovery) of cultural assets of buildings is a field which has drawn much attention of humankind, and has been conducted on a natural level in each country. In the past, restoration of cultural assets of buildings was conducted by a small number of experts and restoration information was shared by the small number of experts. However, the development of scientific technologies and rapid informatization have enabled restoration information to be shared by the public and utilized for the purpose of learning.

Cultural asset information of buildings preserved and managed traditionally in the form of two-dimensional (2D) data such as design drawings, photo images, and the like, are digitized to systematically manage and provide a great deal of information. Information on cultural assets of buildings digitized into 3D data may also be utilized for an operation such as restoration of cultural assets of an actual building which has been conducted largely depending on knowledge and knowhow of a small number of experts, or the like. Digitized information on cultural assets of buildings may be effectively preserved, managed, and shared. Also, effective means using digitized information on cultural assets of buildings may be provided.

The basis in restoring and recovering, digitally expressing, and visualizing cultural assets of buildings is members as components constituting a building. In preserving, restoring, and recovering cultural assets of buildings, shapes of members, a process and method of connecting members, and a process and method of assembling members have meanings and values as cultural assets by themselves.

An existing computer aided design (CAD) or building information modeling (BIM) technology employs a parametric modeling scheme to design a 3D model of components constituting a digital building. Here, in the process of creating a parametric model, a user creates and edits a 3D model using a model creation tool and designates each parameter required for expressing an appearance of the created 3D model one by one. However, in case of the process of creating a parametric model, even when a simple 3D parametric model is created, the user should designate all required parameters manually, requiring a relatively large amount of time and effort. In particular, for a building including a plurality of atypical components with complicated structures like traditional buildings, the existing parametric model creating process causes a severe problem.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for modeling a building component with the smallest amount of time and effort.

The present invention has also been made in an effort to provide a method for simply creating a template of a building component and a method for simply creating a primitive, by using a building component modeling apparatus.

An exemplary embodiment of the present invention provides a method for creating a template of a first component as a building component by a building component modeling apparatus. The template creating method may include: recording a process of creating the first component through at least one first primitive among a plurality of building primitives; analyzing the process of creating the first component to extract at least one first parameter defining the first component; and creating a template of the first component by using the at least one first parameter.

The recording may include: selecting the at least one first primitive among the plurality of primitives included in a primitive database; editing the at least one first primitive to create the first component; and recording the editing action over time.

The editing may include editing the at least one first primitive on a 3D spatial screen according to a user input.

The extracting may include analyzing the process of creating the first component to create first information expressing an appearance of the first component in units of primitives.

The first information may include position information and attribute information of each of the first primitives.

The extracting may further include analyzing a geometrical relation between the first primitives based on the first information and including the geometrical relation in the first information.

The geometrical information may include information on a connection relation between the first primitives and information on an overlapping relation between the first primitives.

The extracting may further include creating the first parameter for changing an appearance of the first component by using the geometrical relation information and the attribute information of the first primitive.

The extracting may further include modifying the created first parameter according to a user input.

The extracting may further include including the first parameter in the first information.

The creating of a template may include creating the temperate by using the geometrical information of the first component and the first parameter, and storing the created template in a template database.

The primitive database may include geometrical information defining an appearance of the first primitive; and a second parameter for changing the appearance of the first primitive.

Another embodiment of the present invention provides an apparatus for modeling a building component. The building component modeling apparatus may include: a first creation processor configured to create a first component as a building component by using at least one first primitive among a plurality of building primitives according to a user input; a second creation processor configured to analyze a process of creating the first component to create at least one first parameter defining the first component; and a third creation processor configured to create a first template corresponding to the first component by using the at least one first parameter.

The building component modeling apparatus may further include a shape analyzer configured to split each of the first template and a second template stored in a template database into a plurality of objects, cluster the plurality of objects based on shape similarity to create at least one cluster, and create an object representing each of the at least one cluster. The second template may correspond to a second component as a building component different from the first component.

The building component modeling apparatus may further include a primitive creation processor configured to create a primitive corresponding to the object created by the shape analyzer and store the created primitive in a primitive database.

Yet another embodiment of the present invention provides a method for creating a building primitive by a digital building component modeling apparatus. The primitive creating method may include: splitting each of at least one template stored in a template database into a plurality of objects; clustering the plurality of objects based on shape similarity to create at least one cluster; creating at least one first object representing each of the at least one cluster; and creating at least one first primitive corresponding to each of the first objects.

Each of the templates corresponds to each digital building component.

The primitive creating method may further include, when the first primitive does not exist in the primitive database, storing the first primitive in the primitive database.

### BRIEF DESCRIPTION OF THE DRAWINGS

FIG. 1 is a view illustrating a building component modeling apparatus according to an exemplary embodiment of the present invention.

FIG. 2 is a view illustrating an example of building primitives according to an exemplary embodiment of the present invention.

FIG. 3 is a view illustrating an example of a building component defined using a building primitive according to an exemplary embodiment of the present invention.

FIG. 4 is a view illustrating an example of result values generated through a geometrical analysis process and a parameter creation process according to an exemplary embodiment of the present invention.

FIG. 5 is a flowchart illustrating a process of creating a template of a building component according to an exemplary embodiment of the present invention.

FIG. 6 is a view illustrating a building component modeling apparatus according to another exemplary embodiment of the present invention.

FIG. 7 is a flowchart illustrating a process of creating a building primitive according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A building component modeling apparatus according to an exemplary embodiment of the present invention defines a building component having a desired shape by arranging at least one building primitive in a three-dimensional (3D) space through a user interface. The building component modeling apparatus automatically creates a template of a defined building component by analyzing 3D geometrical information of the building component. Here, a building component (or a building member) refers to a 3D graphics model, the smallest component forming a digital building. A building primitive (hereinafter referred to as a ‘primitive’) is a model in a basic shape in 3D modeling. At least one primitive is arranged in a 3D space to define appearances of various 3D building component models. A template of a building component (hereinafter referred to as ‘template’) denotes a structure including geometrical information representing an appearance of a building component and a parameter required for changing an appearance of a building component. A user may change an appearance of a building component into a desired shape by changing a parameter value of a template. Parameters represent geometrical variables (e.g., height, width, area, etc.) defining a 3D model, and each building component has a set of parameters capable of changing a detailed appearance, while maintaining a unique shape thereof.

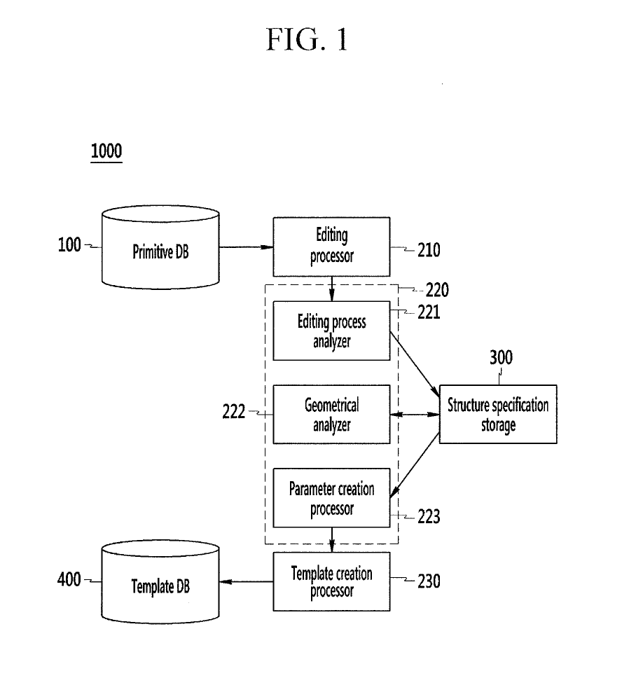

FIG. 1 is a view illustrating a building component modeling apparatus 1000 according to an exemplary embodiment of the present invention.

The building component modeling apparatus 1000 includes a primitive database 100, an editing processor 210, a first creation processor 220, a template creation processor 230, a structure specification storage 300, and a template database (DB) 400.

The primitive DB 100 stores and manages at least one primitive. The primitive DB 100 may retrieve a primitive desired by a user from stored primitives and allow the retrieved primitive to be used for editing a building component. Meanwhile, a predefined primitive may be registered in the primitive DB 100, or a new primitive created by a primitive creation process according to an exemplary embodiment of the present invention may be registered in the primitive DB 100. Here, a primitive includes a 3D object (e.g., box, cylinder, cone, sphere, torus, etc.) in a basic shape in 3D graphics modeling. A primitive may also include objects frequently used to constitute a building component (e.g., a traditional building component). Meanwhile, an element (or entity) of the primitive DB 100 includes geometrical information defining an appearance of each primitive and parameter information required for changing appearance of each primitive.

The editing processor 210 provides a function of editing a primitive to allow a user to define (or create) a building component in a desired shape through a graphical user interface. When the user searches the primitive DB 100 and selects a desired primitive, the editing processor 210 arranges the selected primitive on a 3D spatial visualization screen according to a user input. Here, the 3D spatial visualization screen is provided through a user interface. In order to create a building component, the user arranges the selected primitive using an editing function provided by the editing processor 210. Here, the editing function provided by the editing processor 210 includes a movement and a rotation of a primitive object and a change in a size of the primitive object. Meanwhile, every behavior (i.e., every editing action) done by the user during an editing process is recorded in the form of a script according to the passage of time at which behaviors have occurred.

The first creation processor 220 analyzes the creation process (or the editing process) of the building component (hereinafter referred to as a ‘first building component’) created by the editing processor 210 to create at least one parameter defining the first building component. In detail, the first creation processor 220 includes an editing process analyzer 221, a geometrical analyzer 222, and a parameter creation processor 223.

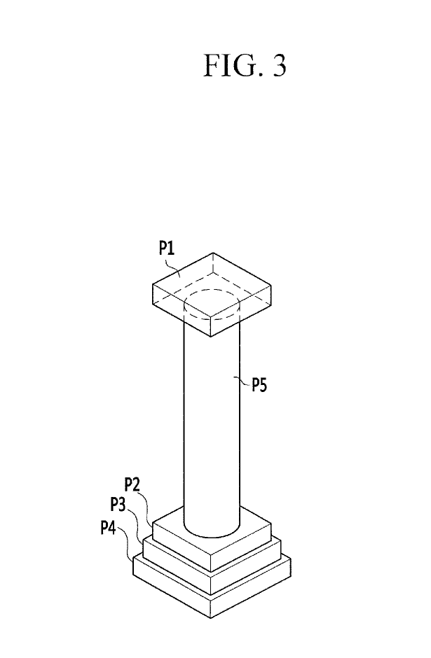

The editing process analyzer 221 receives the editing process script recorded by the editing processor 210. The editing process analyzer 221 analyzes an editing process defining an appearance of the first building component by using an editing process script. The editing process analyzer 221 converts the first building component which has completely undergone the editing process into a component data structure. Here, the component data structure, which is an internal data structure expressing the first building component, is a building component structure specification. The building component structure specification includes information expressing geometric information of the building component (e.g., the first building component) created by the user in units of primitives. The building component structure specification (hereinafter referred to as a ‘first structure specification’) of the first building component may include information of at least one primitive (hereinafter referred to as a ‘first primitive’) used to create the first building component, position information of each of the first primitives, and attribute information of each of the first primitives. The first structure specification created by the editing process analyzer 221 will be described in detail with reference to FIG. 3.

The geometrical analyzer 222 analyzes an appearance of the first building component based on the first structure specification. Here, the geometrical information of the first building component representing the analyzed appearance of the first building component may include information on a connection relation between the first primitives and information on an overlapping relation between the first primitives. In detail, based on the analysis results (e.g., the first structure specification) from the editing process analyzer 221, the geometrical analyzer 222 obtains features defining the appearance of the first building component from the position information and attribute information of each of the first primitives in the 3D space. Here, the features may include a feature (e.g., 8 points in case of a box, a central point of a circle forming the base in case of a cylinder, etc.) defining a shape of an object. The geometrical analyzer 222 stores the features (hereinafter referred to as ‘first features’) defining the appearance of the first building component in the first structure specification.

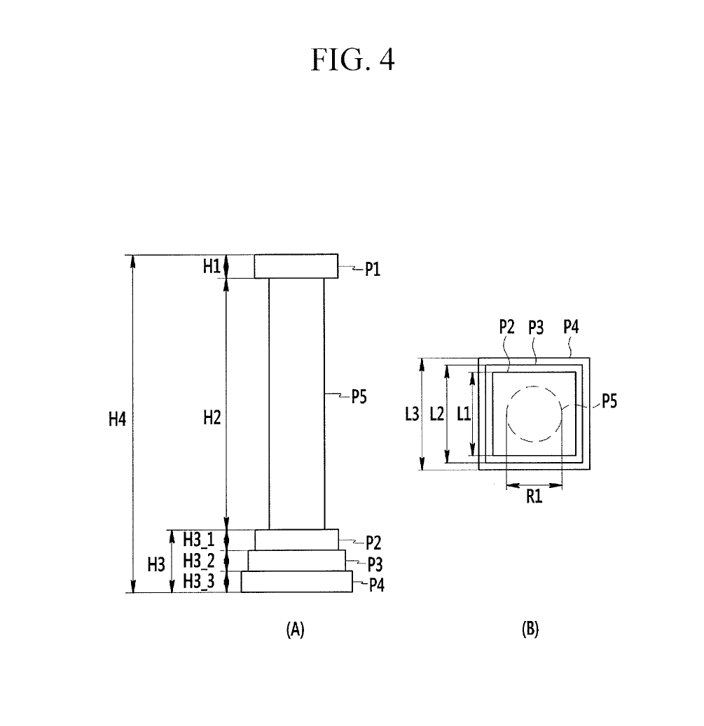

The parameter creation processor 223 automatically creates optimized parameters defining the first building component in consideration of the first structure specification (specifically, the first features, a geometrical relation between the first primitives (e.g., the connection relation and overlapping relation between the first primitives), and the attribute of each of the first primitives). Meanwhile, the parameters (hereinafter referred to as ‘first parameters’) created by the parameter creation processor 223 are stored in the first structure specification. The first parameters will be described in detail with reference to FIG. 4.

The structure specification storage 300 stores the first structure specification.

The template creation processor 230 creates a template (hereinafter referred to as a ‘first template’) corresponding to the first building component by using the first parameters. In detail, the template creation processor 230 extracts geometrical information (information expressing how the first building component looks) of the first building component and the first parameters from the first structure specification, and creates a first template in the form of a script using the same. Here, as mentioned above, the first template includes geometrical information defining the appearance of the first building component and a set of parameters required for deforming the appearance of the first building component. The first template is registered in the template DB 400.

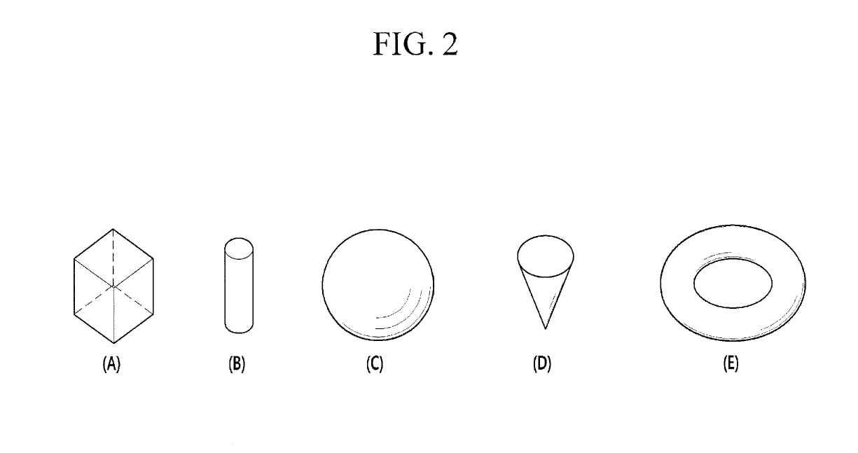

FIG. 2 is a view illustrating an example of building primitives according to an exemplary embodiment of the present invention.

In FIG. 2, (A) is a box primitive, (B) is a cylinder primitive, and (C) is a sphere primitive. Also, in FIG. 2, (D) is a cone primitive, and (E) is a torus primitive.

FIG. 3 is a view illustrating an example of a building component defined using a building primitive according to an exemplary embodiment of the present invention. Specifically, FIG. 3 illustrates a case of creating a columnar building component.

The user may select four box primitives P1 to P4 and one cylinder primitive P5 from among a plurality of primitives provided from the primitive DB 100. The user may arrange three box primitives P2 to P4 through an editing function provided from the editing processor 210 to define the stay of a pillar, arrange one cylinder primitive P5 to define a pillar part of the pillar, and arrange the one box primitive P1 to define the top of the pillar.

In a case in which the first building component has a shape such as illustrated in FIG. 3, the first structure specification may include information indicating that the building component is composed of four box primitives P1 to P4 and one cylinder primitive P5. The first structure specification may include position information of the primitives P1 to P4 and attribute information of the primitives P1 to P5. For example, the attribute information defining the box primitives P1 to P4 may include height, width, and length, and the attribute information defining the cylinder primitive P5 may include radius and height.

FIG. 4 is a view illustrating an example of result values generated through a geometrical analysis process by the geometrical analyzer 222 and a parameter creation process by the parameter creation processor 223 according to an exemplary embodiment of the present invention. In detail, FIG. 4 illustrates an example of an appearance (appearance of the pillar) of the first building component and the first parameters when the first building component has such a shape as illustrated in FIG. 3.

In FIG. 4, (A) illustrates a front side of the first building component having a columnar shape. In FIG. 4, (B) is a plan view illustrating the stay of the pillar of the first building component. The first parameters H1-H4, H3_1-H3_3, L1-L3, and R1 define the first building component having the columnar shape. In detail, the parameter H1 defines the height of the top of the pillar, the parameter H2 defines the height of the pillar part, and the parameter H3 defines the height of the stay of the pillar. The parameters H3_1, H3_2, and H3_3 define the heights of layers of the stay of the pillar, respectively. The parameter H4 defines the overall height of the pillar. The parameter L1 defines the length of a first layer of the stay of the pillar, the parameter L2 defines the length of a second layer of the stay of the pillar, and the parameter L3 defines the length of a third layer of the stay of the pillar. The parameter R1 defines the diameter of the pillar part.

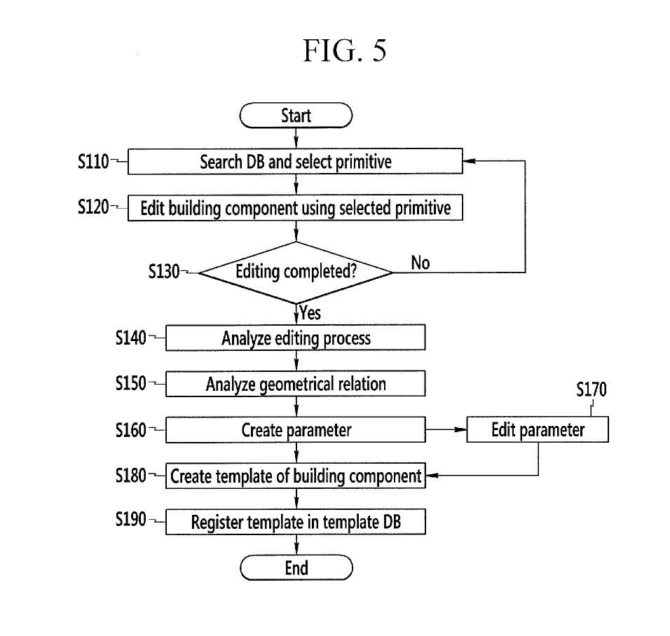

FIG. 5 is a flowchart illustrating a process of creating a template of a building component according to an exemplary embodiment of the present invention.

The user may search for a first primitive having a desired shape among a plurality of primitives provided from the primitive DB 100 and select the same (110).

The user edits the first primitive by using the user interface and the editing functions (e.g., movement, rotation, size adjustment, etc.) provided from the editing processor 210 (S120). Steps S110 and S120 are repeatedly performed until the building component having a desired shape is completed.

When editing is completed, namely, when the appearance of the first building component is completed (S130), the editing process analyzer 221 analyzes the editing process based on editing process records (S140).

The geometrical analyzer 222 analyzes a geometrical relation between the first primitives by using the geometrical information and parameters of the first primitives interpreted through the editing process analysis (S140) (S150).

The parameter creation processor 223 automatically creates the first parameters defining the first building component based on the analysis results of step S150 (S160).

The first parameters and the appearance of the first building component may be displayed on the user interface. The user may check the displayed first parameters, and when a parameter among the first parameters needs to be deleted or when a parameter needs to be added to the first parameters, the user may modify the first parameters through the user interface (S170).

The template creation processor 230 creates a first template of the first building component by using the first parameters (S180). The template creation processor 230 registers the first template in the template DB 400 (S190).

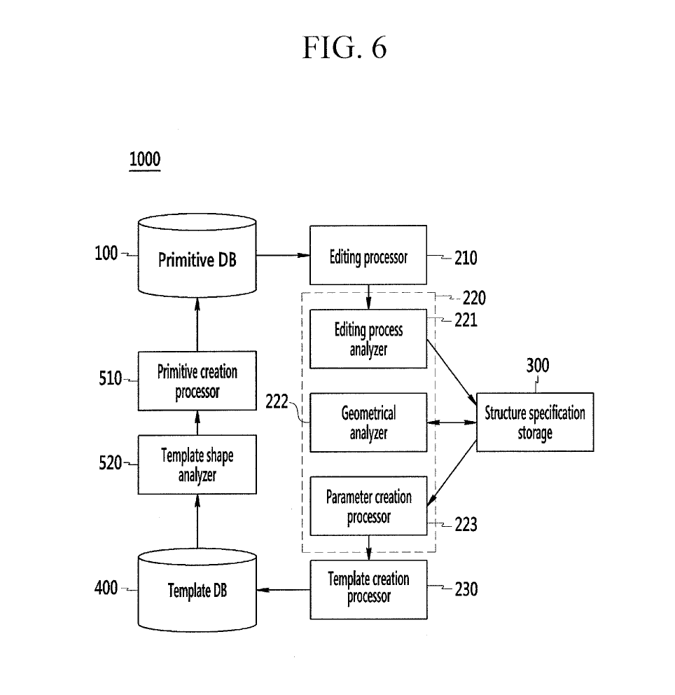

FIG. 6 is a view illustrating a building component modeling apparatus 1000 according to another exemplary embodiment of the present invention. The building component modeling apparatus 1000 of FIG. 6 further includes components (a primitive creation processor 510 and a template shape analyzer 520) for creating a new primitive in addition to the components of FIG. 1. Hereinafter, the primitive creation processor 510 and the template shape analyzer 520 of FIG. 6, being different with respect to the components of FIG. 1, will be described in detail.

The template shape analyzer 520 splits each template into a plurality of objects by analyzing a shape of each of the at least one template registered in the template DB 400. In detail, the template shape analyzer 520 splits each template into objects as basic units constituting its appearance based on the results of the shape analysis. The template shape analyzer 520 clusters the plurality of objects based on shape similarity. In detail, the template shape analyzer 520 clusters objects having similar shape among the plurality of split objects by using a shape similarity measurement algorithm. The template shape analyzer 520 creates (or extracts) an object representing each of at least one cluster created through clustering.

The primitive creation processor 510 creates primitives corresponding to representative objects of the clusters respectively created by the template shape analyzer 520. In detail, the primitive creation processor 510 defines an attribute of each of the primitives corresponding to the representative objects of the clusters. The primitive creation processor 510 determines whether the created primitives exist in the primitive DB 100, and when the created primitives do not exist in the primitive DB 100, the primitive creation processor 510 registers the created primitives in the primitive DB 100. The primitives newly registered in the primitive DB 100 may be used to develop a new building component.

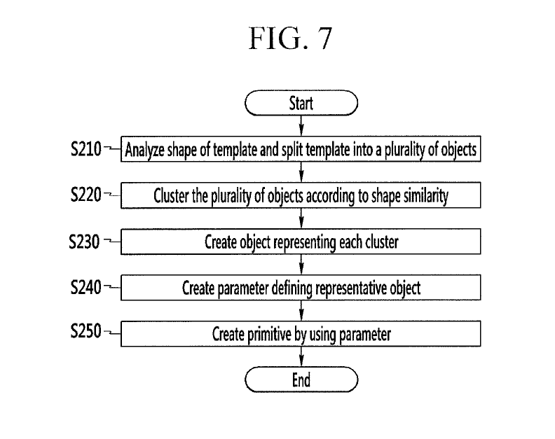

FIG. 7 is a flowchart illustrating a process of creating a building primitive according to an exemplary embodiment of the present invention. Specifically, FIG. 7 illustrates a primitive creation process in which the building component modeling apparatus 1000 analyzes templates registered in the template DB 400 and extracts new primitives that may be advantageously used in the future.

The template shape analyzer 520 analyzes shapes of the templates registered in the template DB 400 (S210). For example, the template shape analyzer 520 may be designed to perform step S210 when a first new template is registered in the template DB 400. Based on the geometrical information of the templates registered in the template DB 400, the template shape analyzer 520 separately stores each template as a 3D object of a minimum unit. That is, the template shape analyzer 520 segments each 3D template model data.

The template shape analyzer 520 clusters objects having a similar appearance according to shape similarity among the 3D objects split in step S210 (S220). In detail, the template shape analyzer 520 calculates shape similarity of the 3D objects split in step S210 by using a shape similarity measurement algorithm, and clusters the 3D objects based on the shape similarity.

The template shape analyzer 520 extracts 3D object models respectively representing clusters created in step S220 (S230). In detail, the template shape analyzer 520 may extract 3D object models respectively representing the clusters by using the shape similarity measurement algorithm.

The primitive creation processor 510 creates parameters defining the 3D object models extracted in step S230 (S240).

The primitive creation processor 510 creates primitives by using the parameters created in step S230 (S250).

When the primitives created in step S250 do not exist in the primitive DB 100, the primitive creation processor 510 registers the corresponding primitives in the primitive DB 100.

In an embodiment of the present invention, a building (e.g., traditional cultural assets of buildings) is digitally expressed and visualized in a virtual 3D space. In an embodiment of the present invention, digital components (members) required for performing assembling and physical simulation, or the like, are modeled.

According to an exemplary embodiment of the present invention, a building component primitive database may be constructed.

According to an exemplary embodiment of the present invention, a user may easily edit an appearance of a building component (member) using primitives provided by a primitive database.

According to an exemplary embodiment of the present invention, parameters defining an appearance of a building component may be automatically created.

According to an exemplary embodiment of the present invention, a building component modeling operation may be simplified through an automatic parameter extracting function provided together with a primitive-based model editing function.

Also, the present invention, which is a technology for 3D modeling a building component (member), may be used for building recovery, digital expression for experience study, and the like.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for creating a template of a first component as a building component by a building component modeling apparatus, comprising:
recording a process of creating the first component through at least one first primitive among a plurality of building primitives;
analyzing the process of creating the first component to extract at least one first parameter defining the first component; and
creating a template of the first component by using the at least one first parameter.

2. The method of claim 1, wherein the extracting comprises analyzing the process of creating the first component to create first information expressing an appearance of the first component in units of primitives.

3. The method of claim 2, wherein the first information comprises position information and attribute information of each of the first primitives.

4. The method of claim 3, wherein the extracting further comprises analyzing a geometrical relation between the first primitives based on the first information and including the geometrical relation in the first information.

5. The method of claim 4, wherein the geometrical information comprises information on a connection relation between the first primitives and information on an overlapping relation between the first primitives.

6. The method of claim 5, wherein the extracting further comprises creating the first parameter for changing an appearance of the first component by using the geometrical relation information and the attribute information of the first primitive.

7. The method of claim 6, wherein the extracting further comprises modifying the created first parameter according to a user input.

8. The method of claim 7, wherein the extracting further comprises including the first parameter in the first information.

9. The method of claim 8, wherein
the creating of a template comprises:
creating the temperate by using the geometrical information of the first component and the first parameter; and
storing the created template in a template database.

10. The method of claim 1, wherein
the recording comprises
selecting the at least one first primitive among a plurality of building primitives included in a primitive database,
wherein the primitive database comprises:
geometrical information defining an appearance of the first primitive; and
a second parameter for changing the appearance of the first primitive.

11. An apparatus for modeling a building component, the apparatus comprising:
a first creation processor configured to create a first component as a building component by using at least one first primitive among a plurality of building primitives according to a user input;
a second creation processor configured to analyze a process of creating the first component to create at least one first parameter defining the first component; and
a third creation processor configured to create a first template corresponding to the first component by using the at least one first parameter.

12. The apparatus of claim 11, wherein
the second creation processor comprises
a first analyzer configured to analyze the process of creating the first component to create first information expressing an appearance of the first component in units of primitives,
wherein the first information comprises position information and attribute information of each of the first primitives.

13. The apparatus of claim 12, wherein
the second creation processor further comprises
a second analyzer configured to analyze a geometrical relation between the first primitives based on the first information and include the geometrical relation information in the first information.

14. The apparatus of claim 13, wherein
the second creation processor further comprises
a parameter creation processor configured to create the first parameter for changing an appearance of the first component by using the geometrical relation information and the attribute information of the first primitive.

15. The apparatus of claim 11, further comprising:
a shape analyzer configured to split each of the first template and a second template stored in a template database into a plurality of objects, cluster the plurality of objects based on shape similarity to create at least one cluster, and create an object representing each of the at least one cluster; and
a primitive creation processor configured to create a primitive corresponding to the object created by the shape analyzer and store the created primitive in a primitive database,
wherein the second template corresponds to a second component as a building component different from the first component.

16. A method for creating a building primitive by a digital building component modeling apparatus, the method comprising:
splitting each of at least one template stored in a template database into a plurality of objects;
clustering the plurality of objects based on shape similarity to create at least one cluster;
creating at least one first object representing each of the at least one cluster; and
creating at least one first primitive corresponding to each of the first objects,
wherein each of the templates corresponds to each digital building component.

17. The method of claim 16, further comprising:
when the first primitive does not exist in a primitive database, storing the first primitive in the primitive database.
